(19) United States
(12) Patent Application Publication
(10) Pub. No.: US 2002/0087878 A1
(43) Pub. Date: Jul. 4, 2002

(54) System and method of protecting privacy

(76) Inventors: Robert G. Ballen, Arlington, VA (US); Gilbert T. Schwartz, Bethesda, MD (US)

Correspondence Address: Hunton & Williams, 1900 K Street, N.W., Washington, DC, 20006-1109, US

(21) Appl. No.: 09/750,307

(22) Filed: Dec. 29, 2000

(51) Int. Cl. H04L 9/00

(52) U.S. Cl. 713/201

(57) ABSTRACT

A service used by Subscribers who desire to protect the confidentiality of their personal and financial information. The service transmits to Companyies holding Subscriber personal information the Subscriber's instructions to maintain the confidentiality of this information, and assists the Subscriber in obtaining the Companies' acknowledgement to honor these instructions.

### FIELD OF THE INVENTION

The present invention relates generally to a method and apparatus to assist users (“Subscribers”) in protecting the confidentiality of personal information, including such data as identification, medical, and financial information. The invention provides Subscribers with an Internet-based service that allows the Subscriber to instruct companies, organizations, and other institutions (“Companies”) to preserve the confidentiality of information about the Subscriber.

### BACKGROUND OF THE INVENTION

Maintaining the confidentiality of information regarding oneself has become increasingly difficult. However, many people wish to maintain their privacy and accordingly wish to maintain the confidentiality of information about themselves that others acquire and save. The problem of maintaining confidentiality of personal and financial information has increased with the rise of the use of computers and the Internet. Computers allow vast compilations of personal data to be archived yet easily accessed and searched when information on a particular person is desired. The Internet has provided the means for this information to be widely and quickly disseminated. The Internet has also provided further means to gather personal information as people use the various services provided over the Internet. It has therefore become increasingly important for individuals to take actions to protect the confidentiality of information about themselves that others have gathered.

One important action to take is to ensure that information provided to Companies with which one interacts is maintained in confidence. Fortunately, there are some legal barriers to dissemination of such information. Companies may also have privacy policies that detail how they may use the personal and financial information that they acquire. To fully take advantage of these protections and to make clear a desire to protect one's personal information, it is prudent to request each Company that has been provided personal information to preserve its confidentiality. Those individuals who wish to protect their own privacy must instruct each company who records their personal information not to use the information for purposes other than those for which it was given and not to share or otherwise disseminate the information. To be most effective these instructions may also need to be periodically renewed or reiterated. Such an undertaking can be onerous and time consuming.

There are organizations that provide information to individuals about protecting privacy and reducing direct marketing solicitations. These organizations include Junkbusters, the Privacy Rights Clearinghouse, Private Citizen, the Consumer Research Institute, and Zero Junk Mail. Each of these organizations maintains a web site that provides information on preserving privacy or limiting direct mail solicitations. The Direct Marketing Association also maintains a list of people who do not wish to receive direct mail, telephone, and email solicitations. However, these organizations do not provide a service to provide an individuals privacy instructions to the organizations that the individual has given personal information.

### SUMMARY OF THE INVENTION

The invention provides a Service that allows users (“Subscribers”) to easily communicate privacy instructions to companies, organizations, and other institutions (“Companies”) to preserve the confidentiality of information about the Subscribers.

The invention is an Internet-based service that assists Subscribers who desire to protect the confidentiality of their personal information. Subscribers indicate to the Service the companies (the “Companies”) that posses personal information about them, and request the Service to instruct these Companies to preserve the confidentiality of that information (the “Privacy Instructions”). The Service communicates the Privacy Instructions to those Companies on behalf of the Subscribers. The Service advises the Subscribers that these communications have taken place. In the event the Company indicates to the Service whether it will comply with the Subscriber's Privacy Instructions, the Service so advises the Subscriber. Depending upon the circumstances, the Service may have additional communications with that Company and Subscribers about the Privacy Instructions.

### BRIEF DESCRIPTION OF THE DRAWINGS

FIG. 1 shows a flowchart of the basic method of the present invention.

FIG. 2 shows the information flow during the Subscriber sign up process.

FIG. 3 shows the information flow during communication of Subscriber privacy instructions to a Company.

FIG. 4 shows the information flow in the event a Company responds that it will honor all privacy instructions.

FIG. 5 shows the information flow in the event a Company responds that it will honor privacy instructions only for some Subscribers.

FIG. 6 shows the information flow in the event a Company initially responds that it will not honor privacy instructions and subsequently agrees to honor all privacy instructions.

FIG. 7 shows the information flow in the event a Company responds and maintains that it will not honor all privacy instructions.

### DETAILED DESCRIPTION OF THE PREFERRED EMBODIMENTS

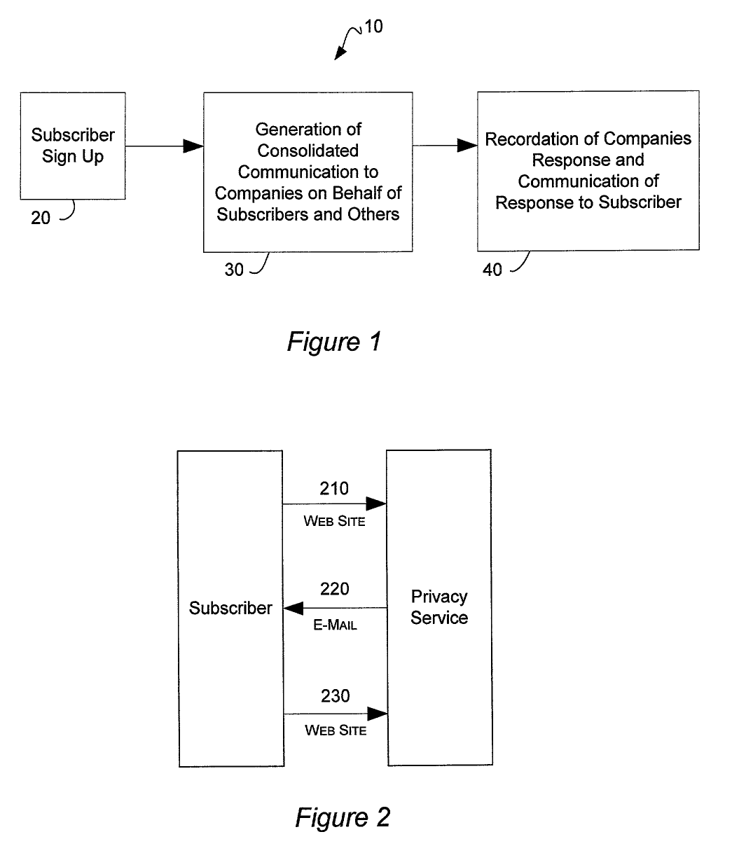

Referring to FIG. 1, an overview of method 10 of providing the Service of the invention is shown. In general the steps of method 10 include the following: Subscriber sign up 20, communication of Privacy Instructions to companies, organizations, and other institutions (“Companies”) 30, and processing responses from Companies to the communications from the Service 40. It should be understood that although these steps are generally accomplished in the order shown in FIG. 1 each step may be continuously repeated as various users (“Subscribers”) and Companies are addressed by the Service. In the preferred embodiment, the Service relies on a computer system programmed to manage Subscriber interactions though a web site and email. The computer system is also used to generate the communications with the Companies. The computer system allows the status of the Privacy Instructions of each Subscriber to various Companies to be recorded and accessed. This allows each Subscriber to access the status of Privacy Instructions communicated on the behalf of the Subscriber. The details of the preferred embodiment of each step of the general method 10 are described below.

### Subscriber Sign Up.

The information flow between the Service and the Subscriber during the Subscriber sign up 20 is shown if FIG. 2. A prospective Subscriber signs up for the Service by visiting a dedicated Internet Web Site, located on the world wide web 210. Through the use of a computer, the prospective Subscriber completes his/her personal profile (“Personal Profile”), accepts the Service'terms and conditions, and selects a unique user name and password. The prospective Subscriber then enters certain information to complete his/her Personal Profile. This information generally includes the prospective Subscriber's complete name, postal address, email address, telephone numbers at work and at home, and social security number. If the Subscriber declines to provide certain identification information, then Companies may be unable to identify the Subscriber. The Service uses a computer system that provides the Web Site. The computer system obtains identification information from the prospective Subscriber when the Subscriber completes the personal profile. The prospective Subscriber is accepted as a Subscriber upon validation by the Service of the payment for the first term of the Service, such as receipt of a Subscriber's check or validation of a credit card he/she has inputted to pay for the first year. The computer system retains the Personal Profile information of each accepted Subscriber in a database.

Upon becoming a Subscriber, the Subscriber receives an on-screen message welcoming him/her to the Service, providing the Subscriber a link to the index of potential companies, organization, and other institutions that the Service supports (the “Company Index”), and providing other information about the Service to the Subscriber. The Service also transmits an email message 220 to the email address entered by the Subscriber on his/her Personal Profile welcoming him/her to the Service and providing other information.

The Subscriber at any time can change his/her Personal Profile (e.g., to change his/her name, password, postal address, email address, telephone number), by visiting the dedicated Web Site 230 and entering his/her user name and password. Procedures are available for a Subscriber who has forgotten his/her user name and/or password. This Subscriber sign up process is ongoing as further potential Subscribers access the Web Site to sign up and various existing Subscribers access their Personal Profiles.

### Communication of Privacy Instructions To Companies.

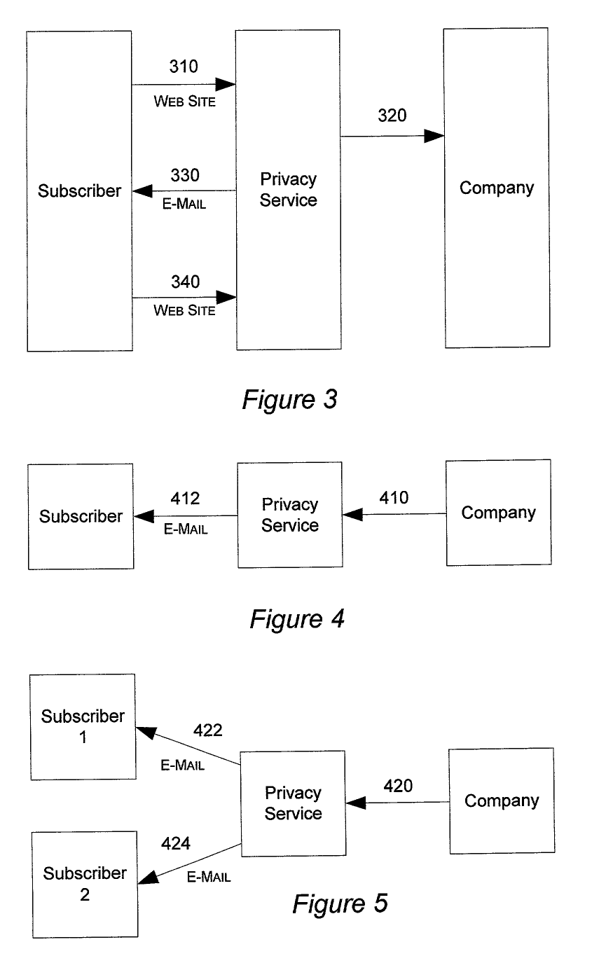

The information flow during the communication of Privacy Instructions to Companies 30 is shown in FIG. 3. The Subscriber enters the Company Index through the Web Site 310 to designate those Companies to which the Service is to communicate Privacy Instructions on behalf of the Subscriber. (The Subscriber may do this after becoming a Subscriber or earlier in that visit to the Web Site prior to signing up for the Service.) Through the selection of Companies in the Company Index by the Subscriber, the computer system obtains a list of the organizations to which Privacy Instructions are to be communicated on behalf of the Subscriber. The indication that a Company has been selected by the Subscriber is recorded by the computer system in the database.

The Service communicates these Privacy Instructions to each of these Companies 320 on the Subscriber's behalf, along with the Privacy Instructions of other Subscribers who have designated that Company during the time period covered by that communication to the Company. This communication is generated after a number of Subscribers have selected the Company. The computer system provides an aggregate list of those Subscribers on whose behalf the Privacy Instructions are to be communicated to the Company. The computer system also records in the database an indication of which Companies have been sent Privacy Instructions on behalf of which Subscribers. The Subscriber may be given the option to vary the content of the Privacy Instructions that are communicated to the Company. Specific request options to be included in the Privacy Instructions that are obtained from the Subscriber may also be recorded in the database. The Company will receive a communication on behalf of a significant number of Subscribers. This communication may be provided to the Company in various forms including written and electronic forms. The Company is more likely to respond to this communication because it is on behalf of a significant number of its customers and because the privacy concerns of a number of customers can be dealt with in an efficient manner together. This process is repeated periodically for each Company in the Company Index.

The communication that is generated includes instructions indicating acceptable or non-acceptable uses of personal information regarding the Subscriber. Such instructions may include for example instructions not to use personal information other than to provide the Subscribers with the products or services they currently receive, instructions not to share personal information with other companies including affiliates, instructions not to use personal information for telemarketing, direct mail or other marketing purposes, and instructions to remove Subscriber names from marketing lists. The communication will also include data enabling the Company to identify each Subscriber to which the instructions apply. The Service selects the information to provide to each Company in an effort to provide only the information that the particular Company may require to identify the Subscribers.

The Subscriber is provided information regarding the communication of Privacy Instructions to designated Companies. Periodically the Service sends an email 330 to the Subscriber indicating the Companies to which his/her Privacy Instructions have been communicated since the previous periodic email. The Subscriber's privacy profile (the “Company Profile”), which is discussed below, also reflects that his/her Privacy Instructions have been communicated to that Company. The Subscriber can view the status of his/her Privacy Instruction by visiting the Web Site 340 as discussed below with regard to the Company Profile of the Subscriber.

### Company Responses To Communications From the Service.

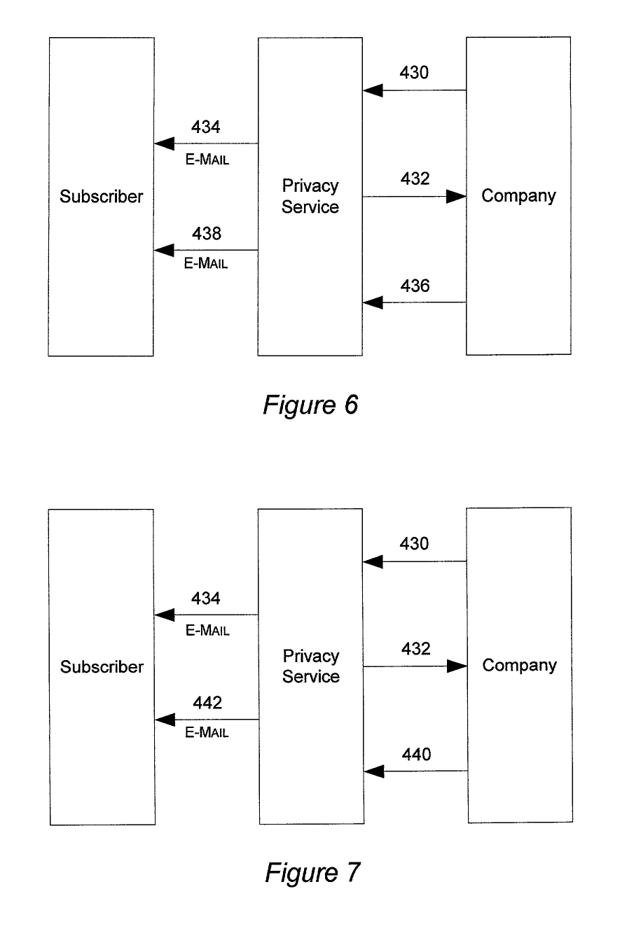

After receiving the communication 320 of the Privacy Instructions on behalf of a number of Subscribers, a Company may react in a number of ways. FIG. 4 shows the flow of information in the event that the Company indicates that it will honor all Privacy Instructions with respect to each Subscriber. FIG. 5 shows the flow of information in the event that the Company indicates that it will honor the Privacy Instruction for only some Subscribers. FIG. 6 shows the information flow in the event a Company initially responds that it will not honor some or all Privacy Instructions and subsequently agrees to honor some or all Privacy Instructions. FIG. 7 shows the information flow in the event a Company responds and maintains that it will not honor any Privacy Instructions.

As shown in FIG. 4, in the event the Company responds 410 that it will honor the Privacy Instructions of all of the Subscribers identified in the communication, the Service sends an email 412 to the Subscriber indicating that the Company has responded that it will honor the Subscriber's instructions. The Service maintains an indication that the Company has indicated it will honor the instructions in the database.

A Company may respond that it will honor Privacy Instructions for some Subscribers but not others. This may occur, for example, when some Subscribers do not provide social security numbers and the Company cannot identify the personal information of the Subscriber without the social security number. FIG. 5 shows the information flow in the event the Company responds 420 that it will honor the Privacy Instructions for some of the Subscribers identified in the communication but not for others, the Service sends an email to the Subscriber summarizing the Company's response as it relates to that Subscriber. For those Subscribers for which the Company indicated it will honor their Privacy Instructions, the email 422 indicates that the Company has responded that it will honor the Subscriber's Privacy Instructions. For those Subscribers for which the Company indicated it would not honor their Privacy Instructions, the email 424 informs the Subscriber of the Company's refusal and suggests to the Subscribers certain additional action they may take. The Service records in the database an indication for each Subscriber of whether the Company will or will not honor the Privacy Instructions.

As shown in FIG. 6, in the event the Company responds 430 that it will not honor certain or all of the instructions identified in the communication, the Service sends a second communication 432 to the Company, and sends an email 434 to the Subscribers informing them of the Company's response and that the Service has sent a second communication to the Company. In the event the Company indicates in response 436 to the second communication 432 that the Company will honor some or all of the Privacy Instructions of each of the identified Subscribers, the Service sends an email 438 to the Subscribers summarizing the Company's response. As shown in FIG. 7, in the event the Company indicates in response 440 to the second communication 432 that the Company will not honor certain or all of the instructions for the identified Subscribers, the Service sends an email 442 to the Subscriber summarizing the Company's response and suggesting to the Subscriber certain action they may take. The response of the Company is maintained with respect to each relevant Subscriber in the database.

### Subscriber Company Profile.

Upon becoming a Subscriber, a Company Profile is created by the Subscriber. The Subscriber can view his/her Company Profile at any time, by visiting the Web Site and entering his/her username and password. Procedures are available for a Subscriber who has forgotten his/her username and/or password. The Subscriber at any time can change his/her Company Profile (e.g., to add or delete a Company to which his/her Privacy Instructions are to be communicated) by visiting the Web Site and entering his/her username and password.

The Company Profile is generated from the data maintained in the database and lists each of the Companies the Subscriber has designated for the Service to communicate the Subscriber's Privacy Instructions, and the status of those Privacy Instructions. A Company's status is marked as “Pending” or the like until the Privacy Instructions are communicated by the Service to the Company. When the Service sends the Subscriber's Privacy Instructions to the Company, the Company's status on the Subscriber's Company Profile is marked “Notification Sent” or the like, noting the date sent. If a Company has become inactive because for example it has gone out of business, that inactive status is indicated on the Company Profile. In the event the Subscriber has deleted the Company from his/her Company Profile in accordance with the procedures described above, that fact also is indicated on the Company Profile.

In the event the Subscriber identifies a Company that does not appear on the Company Index, the Subscriber is able through the Web Site to suggest to the Service the addition of that Company; although the Service is not obligated to add the suggested Company to the Company Index. The Service sends an email to the Subscriber thanking him/her for his/her suggestion and advising that the Subscriber visit the “View New Companies” section of the Web Site in the future to see if the suggested Company has been added to the Company Index.

The Subscriber also receives from time to time certain email communications from the Service about privacy-related developments of potential relevance to the Subscriber, unless the Subscriber has indicated to the Service that he/she does not wish to receive emails of this nature.

Subscribers also have access to Customer Service to email questions or comments. Subscribers also can use Customer Service to cancel the Service, which the Subscriber can do at any time. In addition, Frequently Asked Questions are available through the Web Site to Subscribers, as well as non-Subscriber visitors to the Web Site.

### Renewal.

Shortly before the expiration of the Subscriber's initial or renewal term of one year, the Service sends an email to the Subscriber informing him/her of the upcoming renewal. If the credit card the Subscriber used to pay for the prior term has expired, this email also indicates that the Subscriber's subscription cannot be renewed unless new credit card information is entered in the Subscriber's Personal Profile. Unless the Subscriber cancels the Service prior to the renewal date or, where applicable, an expired credit card is not updated, the Subscriber's subscription is renewed. Following renewal, the Service sends an email to the Subscriber providing certain information about the renewal. As each Company may only retain Privacy Instructions for a limited time, it is desirable to repeat the instructions periodically. Thus, the Service may repeat the step 30, communication of Privacy Instructions to Companies, and step 40, processing responses from Companies to the communications from the Service, on a periodic basis for each Company. Following renewal, the Subscriber's Privacy Instructions continue to be communicated to each of the Companies then appearing on the Subscriber's Company Profile on a periodic basis. If a prior Subscriber fails to renew, the Service will cease to include the prior Subscriber on further communication to Companies.

Other embodiments, uses and advantages of the present invention will be apparent to those skilled in the art from consideration of the specification and practice of the invention disclosed. The specification and examples are exemplary. The scope of the invention is set forth by the following claims.

We claim:

1. A method for protecting consumer privacy comprising the steps of:
obtaining identification information of a plurality of subscribers;
obtaining a list of organizations from each individual subscriber of the plurality of subscribers, each list of organizations designating organizations to which privacy instructions are to be communicated on behalf of the individual subscriber;
aggregating a list of subscribers wishing to communicate the privacy instructions to a particular organization; and
communicating a request to honor the privacy instructions to the particular organization on behalf of those on the list of subscribers.

2. The method of claim 1 wherein the steps of obtaining identification information and obtaining a list of organizations include soliciting subscriber input over the internet.

3. The method of claim 1 wherein the steps of obtaining identification information and obtaining a list of organizations include subscriber interaction with a web page.

4. The method of claim 1 wherein said step of aggregating includes aggregating a list of subscribers wishing to communicate privacy instructions for each of a plurality of organizations.

5. The method of claim 1 wherein the step of obtaining a list of organizations includes providing each of the plurality of subscribers with a list of organizations from which to select.

6. The method of claim 1 further comprising the step of communicating, to each subscriber on the list of subscribers, how the particular organization responded to the step of communicating a request to honor privacy instructions.

7. The method of claim 1 further comprising the step of communicating with the particular organization a second time when no response is received to the step of communicating a request to honor privacy instructions.

8. The method of claim 1 further comprising the step of allowing each of the plurality of subscribers to change their identification information.

9. The method of claim 1 further comprising the step of providing each of the plurality of subscribers with access to information regarding status of the request to honor privacy instructions.

10. The method of claim 1 further comprising the step of providing each of the plurality of subscribers with information regarding status of privacy instructions on each organization on the list of organizations obtained from that subscriber.

11. The method of claim 1 further comprising the step of providing each individual subscriber the option to vary the privacy instructions.

12. The method of claim 1 further comprising the step of accepting a plurality of potential subscribers as subscribers.

13. The method of claim 12 wherein said step of accepting includes receiving payment from each of the plurality of potential subscribers.

14. The method of claim 1 further comprising the step of communicating privacy instructions to the particular organization on behalf of those on the list of subscribers periodically.

15. The method of claim 14 further including the steps of:
soliciting renewal payment from each of the plurality of subscribers periodically; and
ceasing to include those subscriber who fail to provide renewal payment on the list of subscribers.

16. A method of protecting consumer privacy comprising the steps of:
obtaining from each individual subscriber of a plurality of subscribers a list of organizations to which the individual subscriber requests instructions to be communicated, the instructions registering limits on use of information regarding the individual subscriber; and
maintaining a database relating each individual subscriber and organizations to which each individual subscriber has requested that instructions be communicated.

17. The method of claim 16 further comprising the steps of:
generating a communication to a selected organization on behalf of a set of the plurality of subscribers who requested the instructions be communicated to the selected organization, the communication including the instructions registering limits on use of information regarding each subscriber of the set of the plurality of subscribers; and
maintaining information in the database relating each subscriber and organizations to which instructions have been communicated on behalf of the subscriber.

18. The method of claim 17 further comprising the steps of:
obtaining from each individual subscriber an indication of specific requests to be included in the instructions registering limits on use of information regarding the individual subscriber; and
maintaining information in the database relating each subscriber, organization, and the specific requests.

19. The method of claim 17 further comprising the steps of:
repeating the step of generating a communication with respect to each organization in the database as required.

20. The method of claim 17 further comprising the steps of:
obtaining from each of the plurality of subscriber identification data; and
maintaining information in the database relating each subscriber and identification data.

21. The method of claim 20 wherein selected identification data is included in the communication to allow the selected organization to identify each subscriber in the set of the plurality of subscribers who requested instructions be communicated to the selected organization.

22. The method of claim 20 further comprising the step of allowing subscribers to change the identification data maintained in the database that related to themselves.

23. The method of claim 20 wherein the database records identification data including postal addresses, email addresses, and telephone numbers of subscribers.

24. The method of claim 20 wherein the database records identification data including social security numbers of subscribers.

25. The method of claim 19 further comprising the steps of sending to a subscriber communications indicating organizations to which communications have recently been sent on behalf of the subscriber.

26. The method of claim 17 further comprising the step of maintaining in the database information regarding a response of the selected organization to the communication.

27. The method of claim 17 further comprising the steps of:
generating a second communication to the selected organization in the event that the selected organization fails to respond to the original communication and in the event that the selected organization refuses to honor the instructions; and
maintaining information in the database regarding the organizations for which a second communication is generated.

28. The method of claim 19 further comprising the step of relaying each response received from an organization to the instructions to each subscriber addressed in the response.

29. The method of claim 28 wherein the step of relaying includes sending a communication to a subscriber that includes
an indication that the organization will honor the instructions in the event the organization indicates it will honor the instructions with respect to the subscriber,
information regarding the refusal of the organization to honor the instructions in the event the organization indicates it will not honor the instructions with respect to the subscriber and suggestions to the subscriber regarding additional action that may be taken.

30. The method of claim 16 further comprising the step of providing a subscriber information in the database regarding that subscriber.

31. The method of claim 16 further comprising the step of obtaining renewal information periodically from each subscriber; and
maintaining the renewal information in the database.

32. The method of claim 31 further comprising the steps of:
generating a communication to a selected organization in which instructions regarding limits on use of information is sent on behalf of a set of the plurality of subscribers who requested instructions be communicated to the selected organization after obtaining renewal information; and
maintaining information in the database relating each subscriber and organizations to which instructions have been communicated on behalf of the subscriber.

33. A computer system apparatus for protecting subscriber privacy comprising a computer programmed with software for maintaining a database of information, the database relating individual subscribers of a plurality of subscribers and organizations which the individual subscribers desire to protect personal information, the software including:
a routine enabling the computer to obtain identification information from the plurality of subscribers;
a routine enabling the computer to obtain an indication of which organizations each individual subscriber desires to protect their personal information; and
a routine enabling the computer to generate communications to organizations including instructions to protect personal information on behalf of a plurality of subscribers.

34. The computer system of claim 33 wherein the software further includes a routine enabling the computer to retain and provide access to information regarding which organizations communications have been generated on behalf of each individual subscriber.

35. The computer system of claim 33 wherein the software further includes a routine enabling the computer to accept and record in the database data regarding a response by an organization to the generated communication.

36. The computer system of claim 35 wherein the routine enabling the computer to obtain identification information and the routine enabling the computer to obtain an indication of which organizations each individual subscriber desires to protect their personal information each generate a web page through which subscribers interact with the computer system.
